(19) United States
(12) Patent Application Publication
(10) Pub. No.: US 2006/0149537 A1
(43) Pub. Date: Jul. 6, 2006

(54) Code conversion method and device for code conversion

(76) Inventor: Yoshimi Shiramizu, TOKYO (JP)

Correspondence Address: Michael E Whitham;Whitham Curtis & Christofferson, 11491 Sunset Hills Road, Suite 340, Reston, VA, 20190, US

(21) Appl. No.: 10/531,899

(22) PCT Filed: Oct. 20, 2003
(86) PCT No.: PCT/JP03/13347

§ 371 Date: Nov. 15, 2005

(30) Foreign Application Priority Data
Oct. 23, 2002 (JP) 2002-307733

(51) Int. Cl. G10L 19/10

(52) U.S. Cl. 704/219

(57) ABSTRACT

A method of converting code, which converts first codes based on a first system to second codes based on a second system, is characterized in that, when the first codes are unavailable, the second codes are obtained by directly using speech parameters which are ever decoded in accordance with the first system and are stored.

### TECHNICAL FIELD

The present invention relates to a method for converting code and a code conversion apparatus therefor.

### BACKGROUND ART

As a method for encoding a speech signal with high efficiency at a medium or low bit rate, a method is widely used in which the speech signal is separated into a linear prediction (LP) filter and an excitation signal that drives the LP filter and then they are encoded. One of the typical methods is a Code Excited Linear Prediction (CELP) method. According to the CELP method, an LP filter is driven by an excitation signal and hence a synthetic speech signal is obtained. Set in the LP filter are LP coefficients which represent frequency characteristics of an input speech. The excitation signal is expressed as a sum of an adaptive code book (ACB) which represents a pitch period of the input speech and a fixed code book (FCB) which includes random numbers and pulses. Here, respective of an ACB component and an FCB component are multiplied by gains (an ACB gain and an FCB gain). The CELP method is described in a conventional art document No. 1: “Code excited linear prediction: High quality speech at very low bit rates”, by M. Schroeder (Proc. of IEEE Int. Conf. on Acoust., Speech and Signal Processing, pp. 937-940, 1985).

By the way, when considering an interconnection between a 3G mobile network and a cable packet network, for example, there is a problem in that a direct interconnection is not possible due to the difference in a standard speech coding system between respective networks. Solutions for the problem include a tandem interconnection.

FIG. 1 shows a configuration of a conventional code conversion apparatus. Codes (first codes) obtained by encoding speech by using a first speech encoding system (a first system) are converted into codes (second codes) which can be decoded by a second system. The conventional code conversion apparatus based on the tandem interconnection will be explained with reference to FIG. 1. A code demultiplexing circuit 1010 demultiplexes the first codes inputted through an input terminal 10 into speech parameters, namely, codes associated with LP coefficients, an ACB, an FCB, an ACB gain and an FCB gain (an LP coefficients code, an ACB code, an FCB code and gain code). Here, the ACB gain and the FCB gain are encoded and decoded collectively. For simplicity, these are referred to as a gain, and the code of the gain is referred to as a gain code. Also, the LP coefficients code, the ACB code, the FCB code and the gain code are outputted to a speech decoding circuit 1050 as a first LP coefficients code, a first ACB code, a first FCB code, and a first gain code, respectively.

It should be noted that a speech code conversion apparatus is disclosed in Japanese Laid Open Patent Application JP-A 2002-202799 (conventional art document No. 2). The speech decoding circuit 1050 receives the first LP coefficients code, the first ACB code, the first FCB code and the first gain code from the code demultiplexing circuit 1010. The speech decoding circuit 1050 decodes these codes on the basis of the decoding method of the first system to generate the speech, and outputs to a speech encoding circuit 1060 the decoded speech as a first decoded speech. The speech encoding circuit 1060 receives the first decoded speech outputted from the speech decoding circuit 1050. The speech encoding circuit 1060 encodes the first decoded speech on the basis of the second decoding method to obtain an LP coefficients code, an ACB code, an FCB code and a gain code. These codes are outputted to a code multiplexing circuit 1020 as a second LP coefficients code, a second ACB code, a second FCB code and a second gain code, respectively.

It should be noted that known as a method of encoding and decoding speech are the above-mentioned document No. 1 and a conventional art document No. 3: “AMR speech codec; Transcoding functions” (3GPP TS 26.090).

The code multiplexing circuit 1020 receives the second LP coefficients code, the second ACB code, the second FCB code and the second gain code outputted from the speech encoding circuit 1060. The code multiplexing circuit 1020 multiplexes these codes, and outputs the thus-generated codes as the second codes through an output terminal 20.

Thus, the code conversion is completed. As described below, a method of calculating an LSP of the current frame by using a past LSP is shown in the section 6.2.3 of a conventional art document No. 4: “AMR speech codec; Error concealment of lost frames” (3GPP TS 26.091).

However, according to the above-mentioned conventional code conversion apparatus, when the first codes are unavailable, a speech signal with deterioration is produced by using a past speech parameter which has been obtained based on the first system and stored. Then, the speech signal is reanalyzed and encoded on the basis of the second system, and thereby the second codes are obtained. Therefore, the conventional code conversion apparatus has a problem that when the first codes are unavailable due to a packet loss and the like, the speech signal obtained by decoding the second codes after the conversion significantly deteriorates in quality.

Regarding the foregoing description, a speech decoding apparatus is disclosed in International Publication WO96/37964. The conventional speech decoding apparatus has an error detection unit, a first presumption unit, a decoding unit, an updating unit, and a second presumption unit. The error detection unit compresses a speech signal in digital data by using a predetermined encoding method, and detects whether there exists a coding error in the received codes or not. When an error is detected, the first presumption unit presumes correct codes from the codes before the error detection, and outputs the presumed codes. When the error detection ends after a predetermined period passes after the error is first detected, the second presumption unit presumes correct codes during the error is detected, based on the codes received after the error detection ends. Then, the second presumption unit outputs the correct codes as presumed codes. The decoding unit converts the presumed codes into a speech signal on the basis of an internal state data which the decoding unit stores internally. The updating unit updates the internal state data based on a result of the decoding.

### DISCLOSURE OF INVENTION

Therefore, an object of the present invention is to provide a method for converting code and a code conversion apparatus therefor which, when the first codes are unavailable, can reduce the deterioration in quality of the speech signal obtained by decoding the second codes.

Other objects, features and advantages and the like of the present invention will be manifested for the persons skilled in the art with reference to the description below.

In an aspect of the present invention, a method of converting code, which converts first codes based on a first system to second codes based on a second system, is characterized in that, when the first codes are unavailable, the second codes are obtained by directly using speech parameters which are ever decoded in accordance with the first system and are stored.

The method of converting code includes: a step of obtaining data of first linear prediction coefficients from the first codes; a step of obtaining data of first excitation signal from the first codes; a step of storing the data of first linear prediction coefficients; a step of storing the data of first excitation signal; a step of calculating data of first linear prediction coefficients from past data of first linear prediction coefficients which are stored; a step of calculating data of first excitation signal from past data of first excitation signal which are stored; a step of obtaining data of second linear prediction coefficients from the data of first linear prediction coefficients; and a step of obtaining data of second excitation signal from the data of first excitation signal.

Also, the method of converting code can include: a step generating a first speech signal by driving a filter having any of first linear prediction coefficients derived from the data of first linear prediction coefficients and second linear prediction coefficients derived from the data of second linear prediction coefficients by using a first excitation signal derived from the data of first excitation signal; and a step of obtaining data of second excitation signal from the first speech signal and any of the first linear prediction coefficients and the second linear prediction coefficients.

Also, it is preferable that the data of excitation signal includes any of an adaptive codebook data, a fixed codebook data and a gain data.

In another aspect of the present invention, a code conversion apparatus, which converts first codes based on a first system to second codes based on a second system, is characterized in that, when the first codes are unavailable, the second codes are obtained by directly using speech parameters which are ever decoded in accordance with the first system and are stored.

Also, the code conversion apparatus includes: a linear prediction coefficients data decoding circuit configured to obtain data of first linear prediction coefficients from the first codes; an excitation signal data decoding circuit configured to obtain data of first excitation signal from the first codes; a linear prediction coefficients data storage circuit configured to store the data of first linear prediction coefficients; an excitation signal data storage circuit configured to store the data of first excitation signal; a linear prediction coefficients data calculating circuit configured to calculate data of first linear prediction coefficients from past data of first linear prediction coefficients which are stored; an excitation signal data calculating circuit configured to calculate data of first excitation signal from past data of first excitation signal which are stored; a linear prediction coefficients data encoding circuit configured to obtain data of second linear prediction coefficients from the data of first linear prediction coefficients; and an excitation signal data generating circuit configured to obtain data of second excitation signal from the data of first excitation signal.

Also, the code conversion apparatus can include a partial decoding circuit configured to generate a first speech signal by driving a filter having any of first linear prediction coefficients derived from the data of first linear prediction coefficients and second linear prediction coefficients derived from the data of second linear prediction coefficients by using a first excitation signal derived from the data of first excitation signal; and an excitation signal data generating circuit configured to obtain data of second excitation signal from the first speech signal and any of the first linear prediction coefficients and the second linear prediction coefficients.

Also, it is preferable that the data of excitation signal includes any of an adaptive codebook data, a fixed codebook data and a gain data.

In another aspect of the present invention, a program that causes a computer to perform processes is provided. The computer serves as a code conversion apparatus which converts first codes based on a first system to second codes based on a second system. The processes are characterized in that, when the first codes are unavailable, the second codes are obtained by directly using speech parameters which are ever decoded in accordance with the first system and are stored.

According to the program, the processes includes: a process of obtaining data of first linear prediction coefficients from the first codes; a process of obtaining data of first excitation signal from the first codes; a process of storing the data of first linear prediction coefficients; a process of storing the data of first excitation signal; a process of calculating data of first linear prediction coefficients from past data of first linear prediction coefficients which are stored; a process of calculating data of first excitation signal from past data of first excitation signal which are stored; a process of obtaining data of second linear prediction coefficients from the data of first linear prediction coefficients; and a process of obtaining data of second excitation signal from the data of first excitation signal.

Also, the processes can include: a process of generating a first speech signal by driving a filter having any of first linear prediction coefficients derived from the data of first linear prediction coefficients and second linear prediction coefficients derived from the data of second linear prediction coefficients by using a first excitation signal derived from the data of first excitation signal; and a process of obtaining data of second excitation signal from the first speech signal and any of the first linear prediction coefficients and the second linear prediction coefficients.

Here, it is preferable that the data of excitation signal includes any of an adaptive codebook data, a fixed codebook data and a gain data.

The above-mentioned program can be stored in a recording medium.

### BRIEF DESCRIPTION OF DRAWINGS

FIG. 1 is a diagram showing a configuration of a conventional code conversion apparatus;

FIG. 2 is a diagram showing a configuration of a code conversion apparatus according to a first embodiment of the present invention;

FIG. 3 is a diagram showing a configuration of an LP coefficients code converting circuit in the first embodiment;

FIG. 4 is a diagram showing a configuration of a partial speech decoding circuit in the first embodiment;

FIG. 5 is a diagram for showing correspondence between an ACB code and an ACB delay, and a method of translating ACB codes in the first embodiment;

FIG. 6 is a diagram showing a configuration of a second excitation signal data generating circuit in the first embodiment;

FIG. 7 is a diagram showing a configuration of an ACB code generating circuit in the first embodiment;

FIG. 8 is a diagram showing a configuration of an FCB code generating circuit in the first embodiment;

FIG. 9 is a diagram showing a configuration of a gain code generating circuit in the first embodiment;

FIG. 10 is a diagram showing a configuration of a code conversion apparatus according to a second embodiment of the present invention;

FIG. 11 is a flow chart showing procedures of a program according to the present invention; and

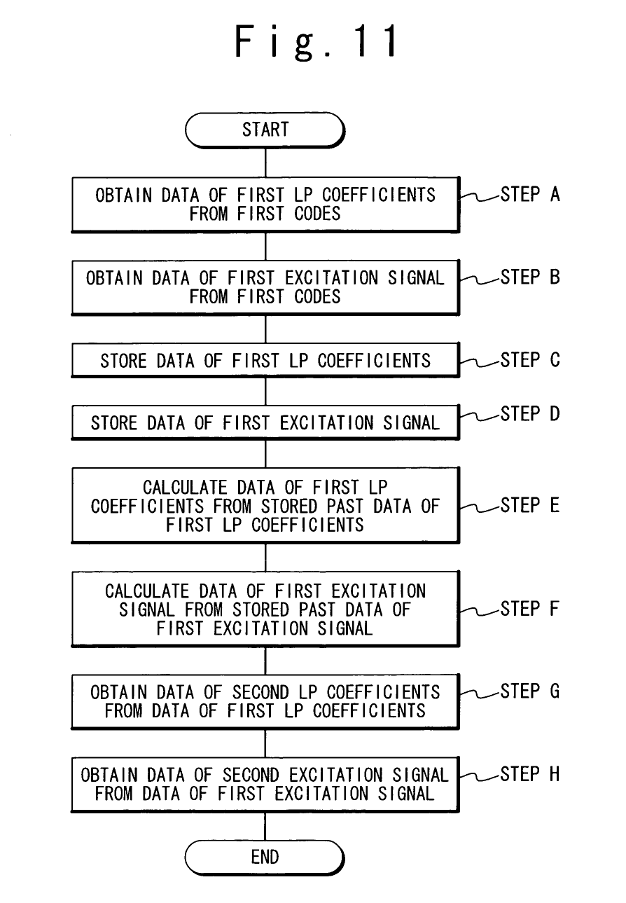

FIG. 12 is a flow chart showing procedures of a code conversion method according to the present invention.

### BEST MODE FOR CARRYING OUT THE INVENTION

A code conversion apparatus according to the present invention is described below in detail with reference to the attached drawings.

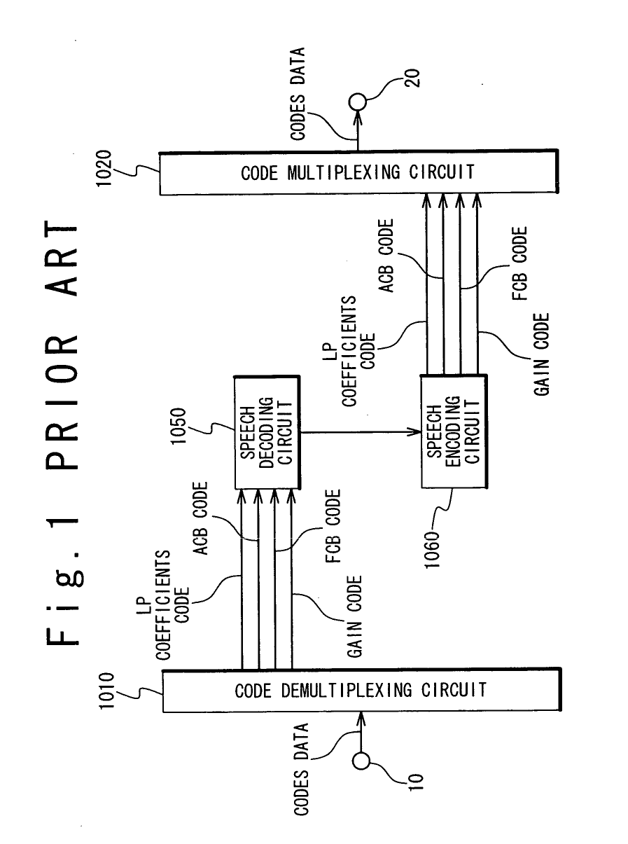

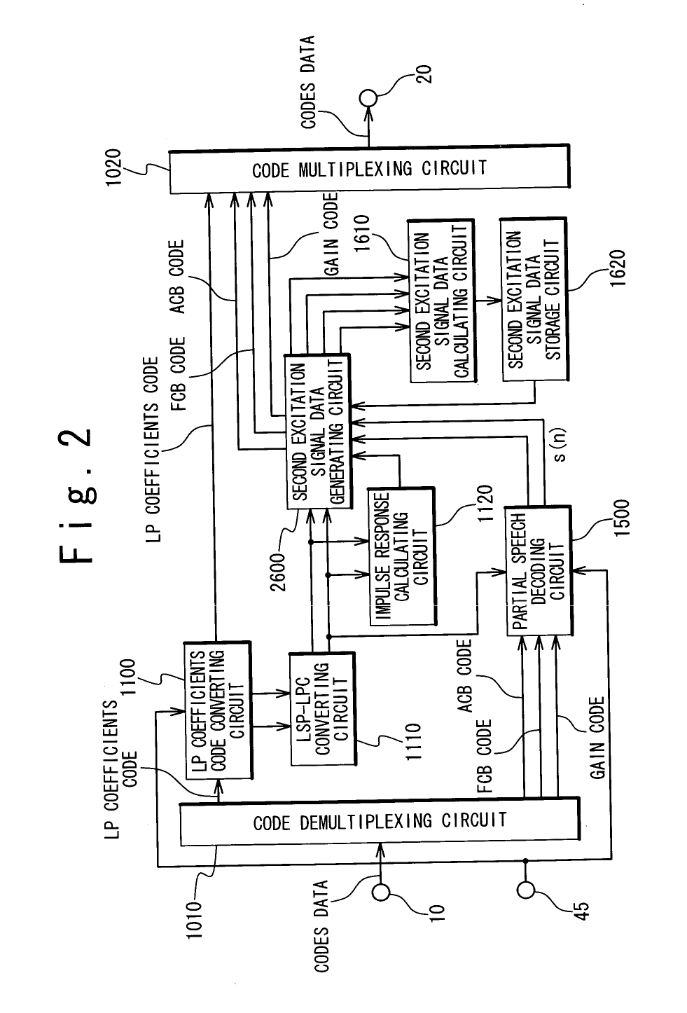

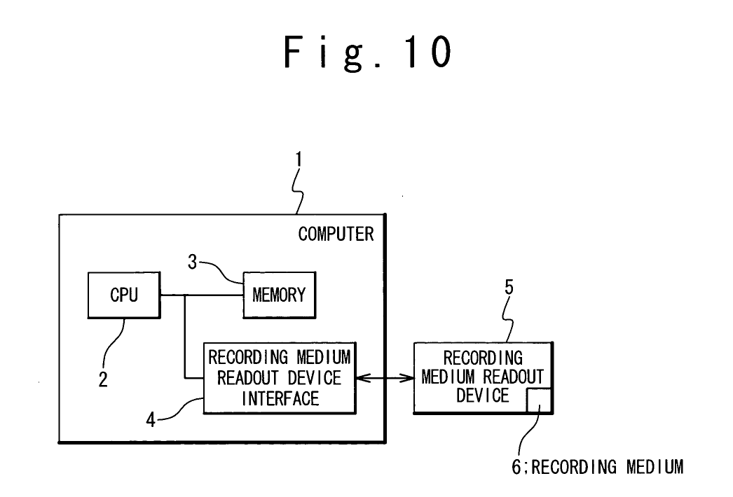

FIG. 2 is a diagram showing a configuration of a code conversion apparatus according to a first embodiment of the present invention. A code conversion method described below can be realized by the code conversion apparatus shown in FIG. 2. Referring to FIG. 2, the code conversion apparatus according to the first embodiment of the present invention includes an LP coefficients code converting circuit 1100 as a linear prediction coefficients code converting circuit, an LSP-LPC converting circuit 1110, an impulse response calculating circuit 1120, a partial speech decoding circuit 1500, a second excitation signal data generating circuit 2600 as an excitation signal data generating circuit, a second excitation signal data calculating circuit 1610, and a second excitation signal data storage circuit 1620, a code multiplexing circuit 20. Here, the same reference number is given to a component which is identical to or similar to the component in the conventional technique shown in FIG. 1. In FIG. 2, an input terminal 10, an output terminal 20, a code demultiplexing circuit 1010, and a code multiplexing circuit 1020 are basically the same as the components shown in FIG. 10 except that a part of the connections are diverged.

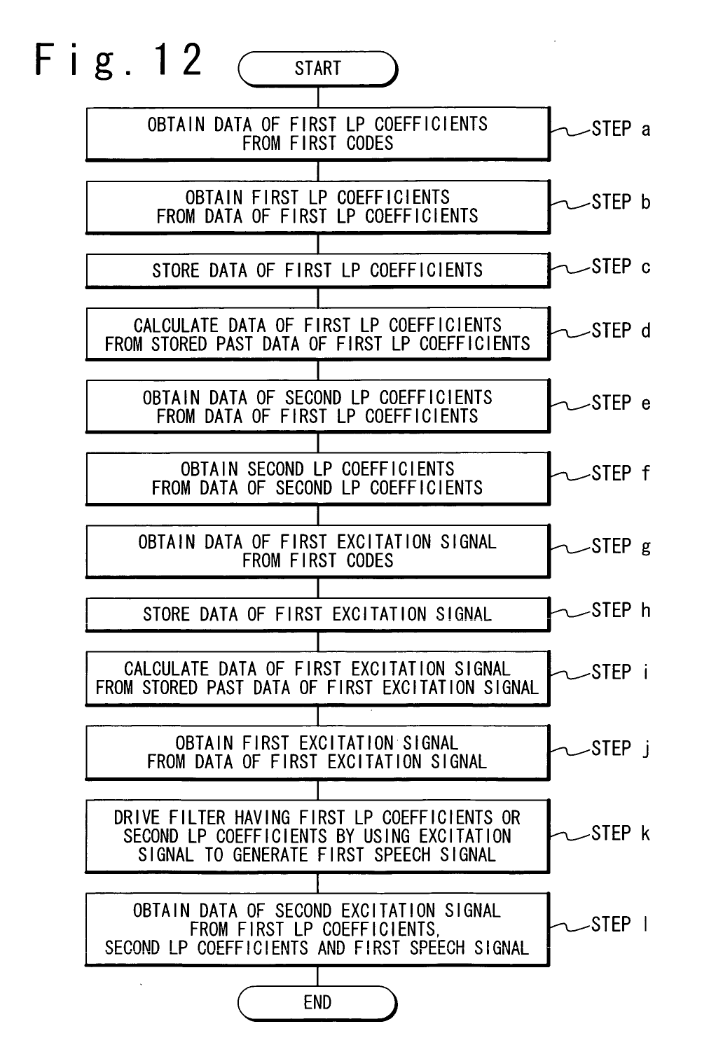

As shown in FIG. 12, the code conversion method according to the present invention includes the following steps.

Step a: Obtaining data of first LP coefficients from first codes.

Step b: Obtaining first LP coefficients from the data of first LP coefficients.

Step c: Storing the data of first LP coefficients.

Step d: Calculating current data of first LP coefficients from the past data of first LP coefficients which are stored.

Step e: Obtaining data of second LP coefficients from the current data of first LP coefficients.

Step f: Obtaining second LP coefficients from the data of second LP coefficients.

Step g: Obtaining data of a first excitation signal from the first codes.

Step h: Storing the data of first excitation signal.

Step i: Calculating current data of first excitation signal from the past data of first excitation signal which are stored.

Step j: Obtaining a first excitation signal from the data of first excitation signal.

Step k: Producing a first speech signal by driving a filter having the first LP coefficients or the second LP coefficients by using the excitation signal.

Step l: Obtaining data of a second excitation signal from the first LP coefficients, the second LP coefficients and the first speech signal.

By the above-mentioned steps according to the present invention, when the first codes are unavailable, the second codes can be obtained by directly using speech parameters which are decoded and stored in the past based on the first system. It is thus possible to reduce the deterioration in quality of the speech signal which is obtained by decoding the second codes.

More specifically, according to the first system, the encoding of the LP coefficients is carried out every T_{fr1} msec cycle (frame), and the encoding of the components of the excitation signal such as an ACB, an FCB and a gain is carried out every T_{sfr1}=T_{fr1}/N_{sfr1} msec cycle (sub-frame). On the other hand, according to the second system, the encoding of the LP coefficients is carried out every T_{fr2} msec cycle (frame), and the encoding of the components of the excitation signal is carried out every T_{sfr2}=T_{fr2}/N_{sfr2} msec cycle (sub-frame). Also, the length of the frame, the number of sub-frames, and the length of the sub-frame in the first system are L_{fr1}, N_{sfr1} and L_{sfr1}=L_{fr1}/N_{sfr1}, respectively. The length of the frame, the number of sub-frames, and the length of the sub-frame in second system are L_{fr2}, N_{sfr2}, and L_{sfr2}=L_{fr2}/N_{sfr2}, respectively. In the description below, it is assumed for simplicity that L_{fr1}=L_{fr2}=N_{sfr1}=N_{sfr2}=2, and L_{sfr1}=L_{sfr2}. For example, when the sampling frequency is 8000 Hz, and the T_{fr1} and T_{fr2} are 10 msec, L_{fr1} and L_{fr2} include 160 samples, and L_{sfr1} and L_{sfr2} include 80 samples.

The code demultiplexing circuit 1010 demultiplexes the first codes inputted through the input terminal 10 to obtain speech parameters, namely, codes corresponding to LP coefficients, an ACB, an FCB, an ACB gain and an FCB gain (an LP coefficients code, an ACB code, an FCB code, and a gain code). Here, the ACB gain and the FCB gain are encoded and decoded collectively. For simplicity, these are referred to as a gain, and the code of the gain is referred to as a gain code. Also, the LP coefficients code is outputted to the LP coefficients code converting circuit 1100 as a first LP coefficients code. The ACB code, the FCB code, and the gain code are outputted to the partial speech decoding circuit 1500 as a first ACB code, a first FCB code, and a first gain code, respectively.

The LP coefficients code converting circuit 1100 obtains data of the first LP coefficients from the first codes which are based on the first system, and stores the data.

Also, the LP coefficients code converting circuit 1100 calculates data of the first LP coefficients from the past data of first LP coefficients which are stored, and then obtains data of second LP coefficients from the data of first LP coefficients. The LP coefficients code converting circuit 1100 receives the first LP coefficients code from the code demultiplexing circuit 1010, and receives a frame lost flag through an input terminal 45. The first LP coefficients code is decoded in accordance with an LSP decoding method in the first system, and thus a first LSP is obtained.

When the first codes are unavailable in the current frame due to a packet loss and the like, the LP coefficients code converting circuit 1100 calculates the first LSP in the current frame from the first LSP in the past which is obtained and stored in a past frame. Whether or not it is available in the current frame is notified by the above-mentioned frame lost flag. The first LSP is quantized and encoded in accordance with an LSP quantization method and an encoding method in the second system, and hence is converted into a second LSP and the corresponding code (a second LP coefficients code). The second LP coefficients code is outputted to the code multiplexing circuit 1020 as a code which is decodable according to an LSP decoding method in the second system. The first LSP and the second LSP are outputted to the LSP-LPC converting circuit 1110.

Here, according to the above-mentioned conventional art document No. 3 and many standard systems such an ITU-T recommendation G.729, the LP coefficients are expressed by a line spectral pair (LSP); (an LSP is used as the data of the LP coefficients). Since the LSP is often encoded and decoded, the encoding and the decoding of the LP coefficients are carried out in an LSP region. As for the conversion from the LP coefficients to the LSP and the conversion from the LSP to the LP coefficients, a well-known method, for example, descriptions in the section 5.2.3 and the section 5.2.4 of the conventional art document No. 3 should be referred to.

The LSP-LPC converting circuit 1110 receives the first LSP and the second LSP outputted from the LP coefficients code converting circuit 1100. The LSP-LPC converting circuit 1110 converts the first LSP to first LP coefficients and converts the second LSP to second LP coefficients. The LSP-LPC converting circuit 1110 outputs the first LP coefficients to the second excitation signal data generating circuit 2600, the partial speech decoding circuit 1500 and the impulse response calculating circuit 1120, and outputs the second LP coefficients to the second excitation data generating circuit and the impulse response calculating circuit 1120. Here, as for the conversion from the LSP to the LP coefficients, the description in the section 5.2.4 of the conventional art document No. 3 should be referred to.

The impulse response calculating circuit calculates impulse responses of the first LP coefficients and the second LP coefficients.

The partial speech decoding circuit 1500 obtains data of first excitation signal from the first codes, and stores the data. Also, the partial speech decoding circuit 1500 calculates data of first excitation signal from the past data of the first excitation signal which are stored in the past. Then, the partial speech decoding circuit 1500 drives a filter having the first LP coefficients by using the first excitation signal, and thereby generates a first speech signal.

The excitation signal data generating circuit 2600 obtains data of the second excitation signal from the first LP coefficients, the second LP coefficients and the first speech signal.

The second excitation signal data calculating circuit 1610 receives the second ACB signal, the second FCB signal, the second ACB gain and the second FCB gain which are outputted from the second excitation signal data generating circuit 2600. The second excitation signal data calculating circuit 1610 obtains a second excitation signal by adding a signal of the product of the second ACB signal and the second ACB gain, and a signal of the product of the second FCB signal and the second FCB gain. Then, the second excitation signal data calculating circuit 1610 outputs the second excitation signal to the second excitation signal data storage circuit 1620.

The second excitation signal data storage circuit 1620 receives the second excitation signal outputted from the second excitation signal data calculating circuit 1610, and stores the received signal. The second excitation signal data storage circuit 1620 outputs a second excitation signal which is inputted and stored in the past to an ACB code generating circuit 2200 in the second excitation signal data generating circuit 2600.

The code multiplexing circuit 1020 receives the second LP coefficients code, the second ACB code, the second FCB code and the second gain code outputted from the speech encoding circuit 1060. The code multiplexing circuit 1020 multiplexes these codes, and outputs the obtained codes as the second codes through the output terminal 20.

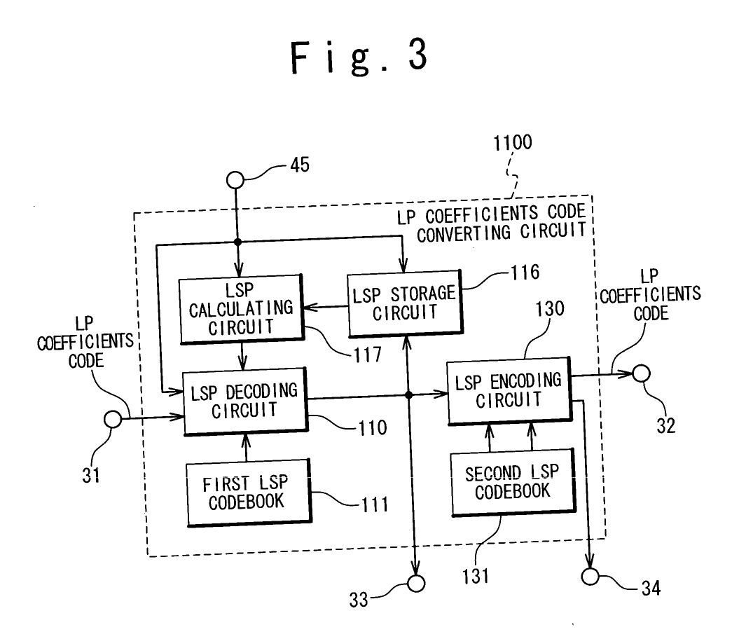

Next, the LP coefficients code converting circuit 1100 will be explained with reference to FIG. 3. FIG. 3 is a diagram showing a configuration of the LP coefficients code converting circuit 1100. Referring to FIG. 3, the LP coefficients code converting circuit 1100 includes an LSP calculating circuit 117, an LSP decoding circuit 110, a first LSP codebook 111, an LSP storage circuit 116, an LSP encoding circuit 130, and a second LSP codebook 131.

The first LSP codebook 111 stores a plurality of LSP sets. Also, the second LSP codebook 131 stores a plurality of LSP sets. The second LSP calculating circuit 117 receives the frame lost flag through the input terminal 45. When the frame lost flag notifies that the current frame is unavailable, the second LSP calculating circuit 117 receives a past first LSP outputted from the LSP storage circuit 116. Then, the second LSP calculating circuit 117 calculates a first LSP in the current frame by using the following equation, and outputs the first LSP to the LSP decoding circuit 110.

$${q}_{j} ( n ) = \frac{{\sum }_{k = 1}^{N} {c}_{k} \cdot {q}_{j} ( n - k )}{{\sum }_{k = 1}^{N} {c}_{k}} , j = 1 , … , P \qquad ( 1 )$$

In the above equation (1), qⱼ(n) is an LSP in the n-th frame, N is a constant (2, for instance), cₖ is a constant (for instance, c₁ is 0.9 and c₂ is 0.1), and P is a linear prediction dimension (10, for instance). As for the method of calculating an LSP in the current frame from a past LSP, the above-mentioned conventional art No. 4 can be referred to.

The LSP decoding circuit 110 receives the frame lost flag through the input terminal 45. When the frame lost flag notifies that the current frame is available, the LSP decoding circuit 110 receives through the input terminal 31 the first LP coefficients code outputted from the code demultiplexing circuit 1010. Then, the LSP decoding circuit 110 reads an LSP corresponding to the first LP coefficients code from the first LSP codebook 111, and determines the read LSP as the first LSP. When the frame lost flag notifies that the current frame is unavailable, the LSP decoding circuit 110 receives a first LSP from the LSP calculating circuit 117. Here, the decoding of the LP coefficients code into the LSP is in accordance with an LSP decoding method based on the first system, and the first LSP codebook 111 for the first system is used. The LSP decoding circuit 110 outputs the first LSP to the LSP encoding circuit 130 and the LSP storage circuit 116. In addition, the LSP decoding circuit 110 outputs the first LSP to the LSP-LPC converting circuit 1110 through the output terminal 33.

The LSP storage circuit 116 receives the first LSP outputted from the LSP decoding circuit 110, and stores the first LSP. When the frame lost flag inputted through the input terminal 45 notifies that the current frame is unavailable, the LSP storage circuit 116 outputs the stored first LSP to the LSP decoding circuit 110.

The LSP encoding circuit 130 receives the first LSP outputted from the LSP decoding circuit 110. The LSP encoding circuit 130 reads second LSPs and the corresponding LP coefficients codes from the second LSP codebook 131 sequentially, and selects a second LSP which has the minimum deviation from the first LSP. Then, the LSP encoding circuit 130 outputs the LP coefficients code corresponding to the selected second LSP as the second LP coefficients code to the code multiplexing circuit 1020 through the output terminal 32. Also, the LSP encoding circuit 130 outputs the second LSP to the LSP-LPC converting circuit 1110 through the output terminal 34. Here, the method of selecting the second LSP, namely, the method of quantizing and encoding the LSP is in accordance with the method of quantizing and encoding the LSP based on the second system, and the LSP codebook for the second system is used. Here, as for the quantization and the encoding of the LSP, the description in the section 5.2.5 of the conventional art document No. 3 can be referred to, for example.

Next, the partial speech decoding circuit 1500 will be explained below in detail. The partial speech decoding circuit 1500 receives the first ACB code, the first FCB code, and the first gain code outputted from the code demultiplexing circuit 1010. Further, The partial speech decoding circuit 1500 receives the first LP coefficients from the LSP-LPC converting circuit 1110, and receives the frame lost flag through the input terminal 45. When the frame lost flag notifies that the current frame is available, the partial speech decoding circuit 1500 decodes the first ACB code, the first FCB code and the first gain code to generate a first ACB delay, a first FCB signal and a first gain by using the ACB signal decoding method, the FCB signal decoding method and the gain decoding method in the first system, respectively. When the frame lost flag notifies that the current frame is unavailable, the partial speech decoding circuit 1500 uses a noise signal as a first FCB signal. Moreover, the partial speech decoding circuit 1500 calculates a first ACB delay and a first gain in the current frame from respective of the past first ACB delay and the past first gain which are decoded and stored in a past frame. Then, the partial speech decoding circuit 1500 produces a first ACB signal by using the first ACB delay. The partial speech decoding circuit 1500 generates a first speech based on the first ACB signal, the first FCB signal, the first gain and the first LP coefficients, and outputs the first speech to the ACB code generating circuit 2200. Here, the second LP coefficients can be used in place of the first LP coefficients.

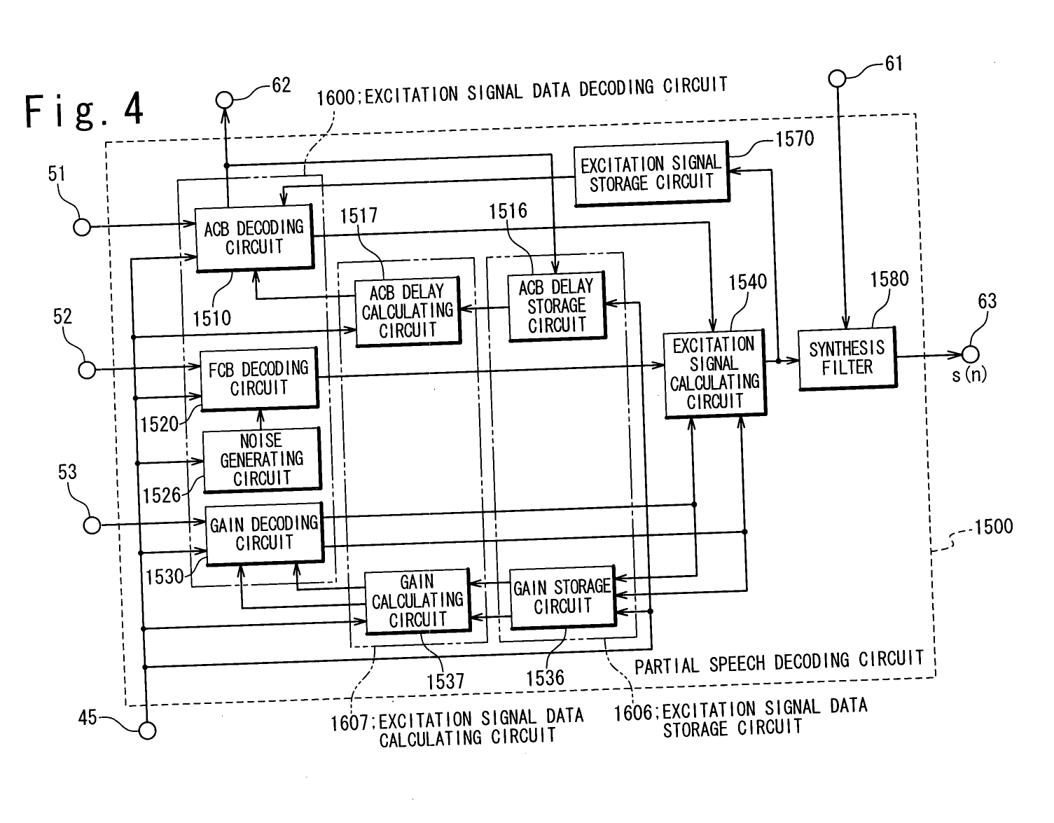

Next, the partial speech decoding circuit 1500 is explained with reference to FIG. 4. FIG. 4 is a diagram showing a configuration of the partial speech decoding circuit 1500. Referring to FIG. 4, the partial speech decoding circuit 1500 includes an excitation signal data decoding circuit 1600, an excitation signal data calculating circuit 1607, an excitation signal data storage circuit 1606, an excitation signal storage circuit 1570, an excitation signal calculating circuit 1540, and a synthesis filter 1580. Moreover, the excitation signal data decoding circuit 1600 includes an ACB decoding circuit 1510, an FCB decoding circuit 1520, a noise generating circuit 1526, and a gain decoding circuit 1530. The excitation signal data calculating circuit 1607 includes an ACB delay calculating circuit 1517 and a gain calculating circuit 1537. The excitation signal data storage circuit 1606 includes an ACB delay storage circuit 1516 and a gain storage circuit 1536.

The excitation signal data decoding circuit 1600 decodes a code corresponding to data of excitation signal to generate the data of excitation signal. The ACB decoding circuit 1510, the FCB decoding circuit 1520 and the gain decoding circuit 1530 of the excitation signal data decoding circuit 1600 receive the first ACB code, the first FCB code and the first gain code outputted from the code demultiplexing circuit 1010 through input terminal 51, 52 and 53, respectively. The ACB decoding circuit 1510, the FCB decoding circuit 1520 and the gain decoding circuit 1530 decode respective of the first ACB code, the first FCB code and the first gain code to generate respective of an ACB delay, an FCB signal and a gain, and output them as a first ACB delay, a first FCB signal and a first gain, respectively. Here, the first gain includes the ACB gain as the first ACB gain and the FCB gain as the first FCB gain. When the frame lost flag inputted through the input terminal 45 indicates that the current frame is unavailable, the noise generating circuit 1526 of the excitation signal data decoding circuit 1600 generates a noise signal as the first FCB signal, and supplies it to the FCB decoding circuit 1520. The ACB decoding circuit 1510 and the gain decoding circuit 1530 receive respective of the first ACB delay and the first gain from respective of the ACB delay calculating circuit 1517 and the gain calculating circuit 1537 of the excitation signal data calculating circuit 1607. Moreover, the ACB decoding circuit 1510 receives a past excitation signal that is outputted from the excitation signal storage circuit 1570. The ACB decoding circuit 1510 generates an ACB signal by using the past excitation signal and the first ACB delay, and outputs the ACB signal as a first ACB signal to the excitation signal calculating circuit 1540. The FCB decoding circuit 1520 outputs the first ACB signal to the excitation signal calculating circuit 1540. The gain decoding circuit 1530 outputs the first ACB gain and the first FCB gain to the excitation signal calculating circuit 1540 and the gain storage circuit 1536 of the excitation signal data storage circuit 1606.

When the frame lost flag inputted through the input terminal 45 indicates that the current frame is not available, the excitation signal data calculating circuit 1607 receives the past first ACB delay and the past first gain, which is decoded and stored in a past frame, from the gain storage circuit 1536 of the excitation signal data storage circuit 1606.

Then, the excitation signal data calculating circuit 1607 calculates the first ACB delay and the first gain in the current frame, and outputs them to the gain decoding circuit 1530 of the excitation signal data decoding circuit 1600.

The ACB delay storage circuit 1516 of the excitation signal data storage circuit 1606 receives and stores the first ACB delay outputted from the excitation signal data decoding circuit 1600. The gain storage circuit of the excitation signal data storage circuit 1606 receives and stores the first gain from the gain decoding circuit 1530. When the frame lost flag inputted through the input terminal 45 indicates that the current frame is unavailable, the excitation signal data storage circuit 1606 outputs the stored past first ACB delay and the stored past first gain to the ACB delay calculating circuit 1517 and the gain calculating circuit 1537 of the excitation signal data calculating circuit 1607, respectively.

Described below in detail are the ACB decoding circuit 1510, the FCB decoding circuit 1520, the gain decoding circuit 1530 and the noise generating circuit 1526 as the components of the excitation signal data decoding circuit 1600. Moreover, the ACB delay calculating circuit 1517 and the gain calculating circuit 1537 as the components of the excitation signal data calculating circuit 1607 will be explained below in detail. Furthermore, the ACB delay storage circuit 1516 and the gain storage circuit 1536 as the components of the excitation signal data storage circuit 1606 will be explained bellow in detail.

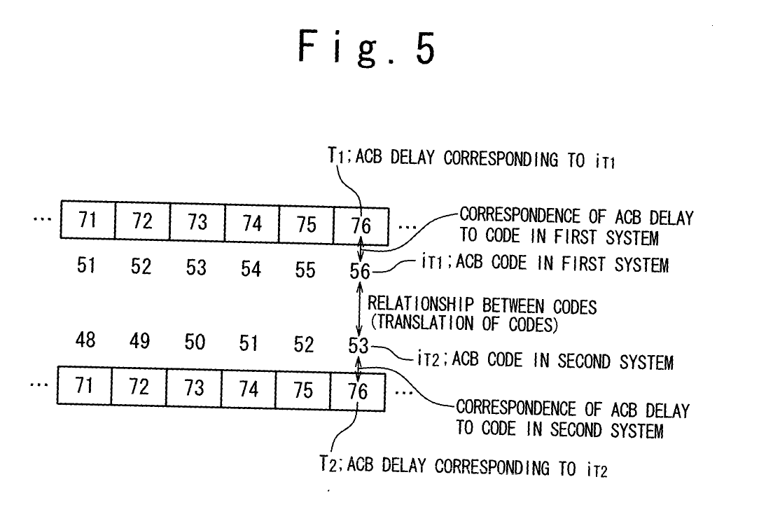

The ACB decoding circuit 1510 receives the past excitation signal outputted from the excitation signal storage circuit 1570, and receives the frame lost flag through the input terminal 45. When the frame lost flag indicates that the current frame is available, the ACB decoding circuit 1510 receives the first ACB code outputted from the code demultiplexing circuit 1010 through the input terminal 51. Then, the ACB decoding circuit 1510 calculates a first ACB delay T1 corresponding to the first ACB code by using the correspondence between the ACB delay and the ACB code in the first system shown in FIG. 5. When the frame lost flag indicates that the current frame is unavailable, the ACB decoding circuit 1510 receives a first ACB delay T1 outputted from the ACB delay calculating circuit 1517. A signal of L_{sfr1} samples corresponding to the sub-frame length from a point at T1 samples before the beginning of the current sub-frame is cut out from the past excitation signal, and thus the first ACB signal is generated. Here, when T1 is smaller than L_{sfr1}, a vector corresponding to the T1 samples is cut out. The vector is repeatedly connected, and hence a signal of L_{sfr1} samples is produced. Then, the first ACB signal is outputted to the excitation signal calculating circuit 1540. The first ACB delay is outputted through an output terminal 62 to an ACB encoding circuit 2220 in an ACB code generating circuit 2200 of the second excitation signal data generating circuit 2600. Here, as for the details of the method of generating the first ACB signal, the description in the section 6.1 and the section 5.6 of the conventional art document No. 3 should be referred to.

The ACB delay calculating circuit 1517 receives the frame lost flag through the input terminal 45. When the frame lost flag indicates that the current frame is unavailable, the ACB delay calculating circuit 1517 receives the past first ACB delay outputted from the ACB delay storage circuit 1516. Then, the ACB delay calculating circuit 1517 calculates a first ACB delay in the current frame by using the following equation, and outputs the first ACB delay to the ACB decoding circuit 1510.

$$d ( n ) = \frac{{\sum }_{k = 1}^{N} {c}_{k} \cdot d ( n - k )}{{\sum }_{k = 1}^{N} {c}_{k}} \qquad ( 2 )$$

Here, d(n) is the ACB delay in the second sub-frame of the n-th frame, N is a constant (2 for instance), cₖ is a constant (for instance, c₁ is 0.9 and c₂ is 0.1). As for the method of calculating the ACB delay in the current frame from the past ACB delay, the description in the section 6.2.3 of the conventional art document No. 4 may be referred to.

The ACB delay storage circuit 1516 receives the first ACB delay outputted from the ACB decoding circuit 1510, and receives the frame lost flag through the input terminal 45. Moreover, the ACB delay storage circuit 1516 stores the first ACB delay. When the frame lost flag indicates that the current frame is unavailable, the stored first ACB delay is outputted to the ACB delay calculating circuit 1517.

The FCB decoding circuit 1520 receives the frame lost flag through the input terminal 45. When the frame lost flag indicates that the current frame is available, the FCB decoding circuit 1520 receives through an input terminal 52 the first FCB code outputted from the code demultiplexing circuit 1010, and outputs the first FCB signal corresponding to the first FCB code to the excitation signal calculating circuit 1540. Here, the decoding of the FCB code to the FCB signal is in accordance with the decoding method for producing the FCB signal in the first system. When the frame lost flag indicates that the current frame is unavailable, the FCB decoding circuit 1520 receives the first FCB signal outputted from the noise generating circuit 1526, and outputs the signal to the excitation signal calculating circuit 1540. Here, the FCB signal is often expressed by a multi-pulse signal defined by pulse positions and pulse polarities. In this case, the first FCB code consists of a code associated with the pulse positions (a pulse position code) and a code associated with the pulse polarities (a pulse polarity code). As for the details of the method of generating the FCB signal expressed by the multi-pulse signal, the descriptions in the section 6.1 and the section 5.7 of the conventional art document No. 3 can be referred to.

The noise generating circuit 1526 receives the frame lost flag through the input terminal 45. When the frame lost flag notifies that the current frame is unavailable, the noise generating circuit 1526 generates a noise signal and outputs it to the FCB decoding circuit 1520 as the first FCB signal. As for the method of generating the noise signal, the description in the section 6.2.3 of the conventional art document No. 4 may be referred to.

The gain decoding circuit 1530 receives the frame lost flag through the input terminal 45. When the frame lost flag indicates that the current frame is available, the gain decoding circuit 1530 receives through an input terminal 53 the first gain code outputted from the code demultiplexing circuit 1010. Also, the gain decoding circuit 1530 reads a gain corresponding to the first gain code from the gain codebook in which a plurality of gains are stored. Here, the decoding of the gain code to the gain is in accordance with the method of decoding for producing the gain in the first system, and the gain codebook for the first system is used. The read gain, namely, the first ACB gain corresponding to the ACB gain, and the first FCB gain corresponding to the FCB gain are outputted to the excitation signal calculating circuit 1540. When the frame lost flag indicates that the current frame is unavailable, the gain decoding circuit 1530 receives the first ACB gain and the first FCB gain outputted from the gain calculating circuit, and outputs them to the excitation signal calculating circuit 1540. Here, when the first ACB gain and the first FCB gain are collectively encoded, a plurality of two-dimension vectors each of which consists of the first ACB gain and the first FCB gain are stored in the gain codebook. Also, when the first ACB gain and the first FCB gain are independently encoded, two gain codebooks are built in. In one of the gain codebooks, a plurality of first ACB gains are stored. In the other of the gain codebooks, a plurality of first FCB gains are stored.

The gain calculating circuit 1537 receives the frame lost flag through the input terminal 45. When the frame lost flag indicates that the current frame is unavailable, the gain calculating circuit 1537 receives the past first ACB gain and the past first FCB gain outputted from the gain storage circuit 1536. Then, the gain calculating circuit 1537 calculates the first ACB gain and the first FCB gain in the current frame by using the following equation, and outputs the calculated gains to the gain decoding circuit 1530.

$$g ( n ) = \frac{{\sum }_{k = 1}^{N} {c}_{k} \cdot g ( n - k )}{{\sum }_{k = 1}^{N} {c}_{k}} \qquad ( 3 )$$

Here, g (n) is the ACB gain or the FCB gain in the second sub-frame of the n-th frame, N is a constant (2 for instance), cₖ is a constant (For instance, c₁ is 0.9 and c₂ is 0.1). As for the method of calculating the ACB gain and the FCB gain in the current frame from respective of the past ACB gain and the past FCB gain, the description in the section 6.2.3 of the conventional art document No. 4 may be referred to.

The gain storage circuit 1536 receives the first ACB gain and the first FCB gain outputted from the gain decoding circuit 1530, and receives the frame lost flag through the input terminal 45. Also, the gain storage circuit 1536 stores the first ACB gain and the first FCB gain. When the frame lost flag indicates that the current frame is unavailable, the gain storage circuit 1536 outputs the stored first ACB gain and the stored first FCB gain to the gain decoding circuit 1530.

The excitation signal calculating circuit 1540 receives the first ACB signal outputted from the ACB decoding circuit 1510, the first FCB signal outputted from the FCB decoding circuit 1520, and the first ACB gain and the first FCB gain outputted from the gain decoding circuit 1530. The excitation signal calculating circuit 1540 calculates the first excitation signal by adding a signal of the product of the first ACB gain and the first ACB signal to a signal of the product of the first FCB gain and the first FCB signal. The first excitation signal is outputted to the synthesis filter 1580 and the excitation signal storage circuit 1570.

The excitation signal storage circuit 1570 receives and stores the first excitation signal outputted from the excitation signal calculating circuit 1540. The excitation signal storage circuit 1570 outputs to the ACB decoding circuit 1510 the past first excitation signal which is inputted in the past and stored.

The synthesis filter 1580 receives the first excitation signal outputted from the excitation signal calculating circuit 1540, and receives through an input terminal 61 the first LP coefficients outputted from the LSP-LPC converting circuit 1110. The synthesis filter 1580 generates a first speech by driving the linear prediction filter having the first LP coefficients by using the first excitation signal. Then, the synthesis filter 1580 outputs the first speech through an output terminal 63 to a target signal calculating circuit 2210 in an ACB code generating circuit 2200 in the second excitation signal data generating circuit 2600. The second LP coefficients can be used in place of the first LP coefficients.

Now, FIG. 2 is referred to again. The second excitation signal data generating circuit 2600 receives the first LP coefficients and the second LP coefficients from the LSP-LPC converting circuit 1110, the first speech and the first ACB delay from the partial speech decoding circuit 1500, the impulse response signal from the impulse response calculating circuit 1120, and the past second excitation signal stored in the second excitation signal data storage circuit 1620. The second excitation signal data generating circuit 2600 calculates a first target signal by using the first speech, the first LP coefficients and the second LP coefficients. Also, the second excitation signal data generating circuit 2600 calculates a second ACB delay, a second ACB signal and an optimum ACB gain by using the past second excitation signal, the impulse response signal, the first target signal and the first ACB delay. Then, the second excitation signal data generating circuit 2600 calculates a second target signal by using the first target signal, the second ACB signal, the optimum ACB gain and the impulse response signal, and hence obtains an FCB signal whose deviation from the second target signal is minimum. The obtained FCB signal is set as a second FCB signal. A weighed square error between the first target signal and a reconstructed speech is calculated by using the first target signal, the second ACB signal, the second FCB signal, the impulse response signal, and the ACB gain and the FCB gain stored in the gain codebook. The second excitation signal data generating circuit 2600 selects a second ACB gain and a second FCB gain with which the weighed square error is minimized. The second ACB signal, the second FCB signal, the second ACB gain and the second FCB gain are outputted to the second excitation signal data calculating circuit 1610. The codes which are decodable in the second system and correspond to the second ACB delay, the second FCB signal, the second ACB gain and the second FCB gain are outputted to the code multiplexing circuit 1020 as the second ACB code, the second FCB code, and the second gain code.

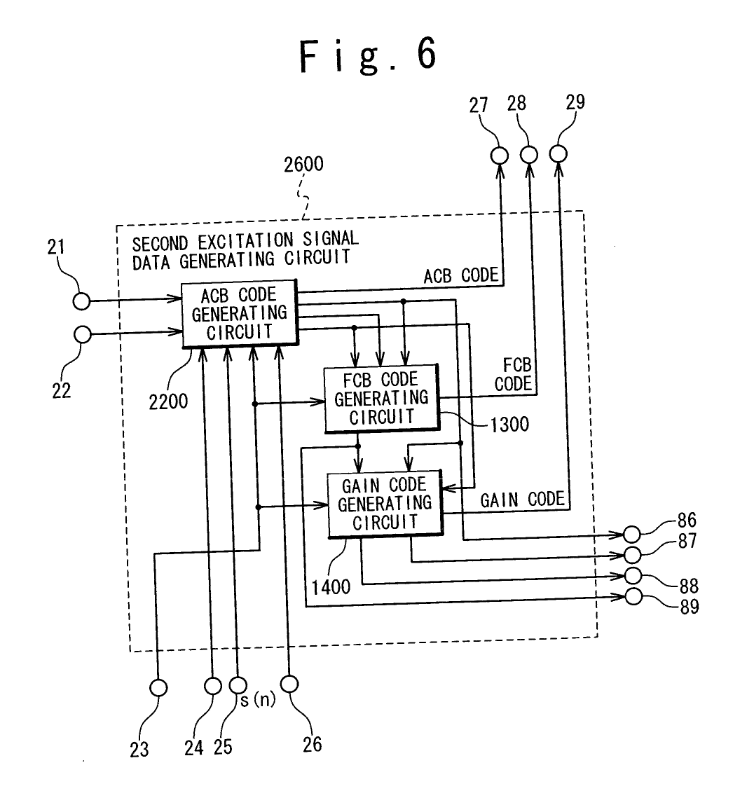

FIG. 6 is a diagram showing a configuration of the second excitation signal data generating circuit 2600. Referring to FIG. 6, the second excitation signal data generating circuit 2600 includes an ACB code generating circuit 2200, an FCB code generating circuit 1300, and a gain code generating circuit 1400.

The ACB code generating circuit 2200 receives the first LP coefficients and the second LP coefficients from the LSP-LPC converting circuit 1110, the first speech and the first ACB delay from the partial speech decoding circuit 1500, the impulse response signal from the impulse response calculating circuit 1120, and the past second excitation signal stored in the second excitation signal data storage circuit 1620. Then, the ACB code generating circuit 2200 calculates a first target signal by using the first speech, the first LP coefficients and the second LP coefficients. Next, the ACB code generating circuit 2200 calculates a second ACB delay, a second ACB signal and an optimum ACB gain by using the past second excitation signal, the impulse response signal, the first target signal and the first ACB delay. The first target signal is outputted to the FCB code generating circuit 1300 and the gain code generating circuit 1400. The optimum ACB gain is outputted to the FCB code generating circuit 1300. The second ACB signal is outputted to the FCB code generating circuit 1300, the gain code generating circuit 1400, and the second excitation signal data calculating circuit 1610. Furthermore, the ACB code generating circuit 2200 outputs an code, which is decodable in the second system and corresponds to the second ACB delay, to the code multiplexing circuit 1020 as a second ACB code.

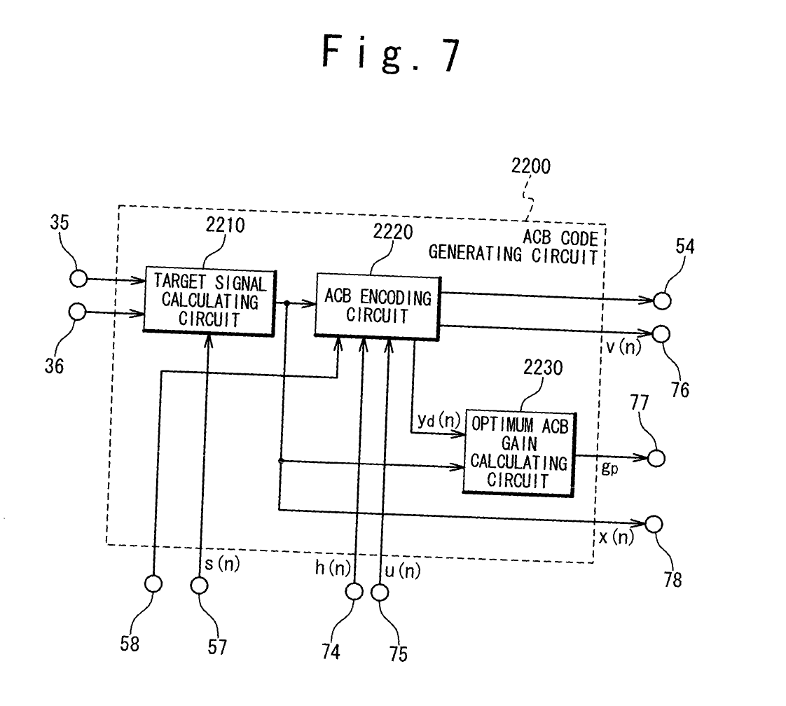

FIG. 7 is a diagram showing a configuration of the ACB code generating circuit 2200. Referring to FIG. 7, the ACB code generating circuit 2200 includes a target signal calculating circuit 2210, an ACB encoding circuit 2220, and an optimum ACB gain calculating circuit 2230.

The target signal calculating circuit 2210 receives through an input terminal 57 the first speech outputted from the synthesis filter 1580 in the partial speech decoding circuit 1500. Also, the target signal calculating circuit 2210 receives the first LP coefficients and the second LP coefficients outputted from the LSP-LPC converting circuit 1110 through an input terminal 36 and an input terminal 35, respectively. First, an audibility weighing filter W(z) is formed by using the first LP coefficients. The audibility weighing filter is driven by using the first speech, and thus an audibility weighed speech signal is produced. Next, an audibility weighing synthesis filter W(z)/A2(z) is formed by using the first LP coefficients and the second LP coefficients. A first target signal x(n) is obtained by subtracting from the audibility weighed speech signal a response of the audibility weighing synthesis filter to zero input. The first target signal x(n) is outputted to the ACB encoding circuit 2220 and the optimum ACB gain calculating circuit 2230. Moreover, the first target signal x(n) is also outputted through an output terminal 78 to a second target signal calculating circuit 1310 in the FCB code generating circuit 1300. As for the details of the method of calculating the first target signal, the description in the section 5.5 of the conventional art document No. 3 can be referred to.

The ACB encoding circuit 2220 receives the first target signal outputted from the target signal calculating circuit 2210, receives through an input terminal 58 the first ACB delay outputted from the ACB decoding circuit 1510 in the partial speech decoding circuit 1500, receives through an input terminal 74 the impulse response signal outputted from the impulse response calculating circuit 1120, and receives through an input terminal 75 the past second excitation signal outputted from the second excitation signal data storage circuit 1620. By making the convolution between the impulse response signal and a signal cut out from the past second excitation signal with the delay k, the ACB encoding circuit 2220 calculates filtered past excitation signals yₖ(n); n=0, . . . , L_{sfr2}−1 with the delay k. Next, a normalized cross-correlation between yₖ(n) and the first target signal x(n) is calculated with respect to a certain delay k within a range whose center value is the first ACB delay. Then, a delay with which the normalized cross-correlation takes a maximum value. This corresponds to selecting a delay with which the square error between x(n) and yₖ(n) takes a minimum value. The selected delay is the second ACB delay d, and the signal cut out from the past second excitation signal with the second ACB delay d is the second ACB signal v(n). Here, the normalized cross-correlation Rxy(k) can be expressed by the following equation.

$${R}_{ky} ( k ) = \frac{{\sum }_{k = 0}^{Lsfr2 - 1} x ( n ) {y}_{k} ( n )}{\sqrt{{\sum }_{n = 0}^{Lsfr2 - 1} {y}_{k} ( n ) {y}_{k} ( n )}} \qquad ( 4 )$$

A self-correlation Rₛₛ(k) of the first target signal can be used in place of R_{xy}(k)

$${R}_{ss} ( k ) = {\sum }_{n = 0}^{Lsfr1 - 1} {S}_{w} ( n ) {s}_{w} ( n - k ) \qquad ( 5 )$$

Here, s_{w}(n) is the first target signal.

Also, a normalized self-correlation R′_{ss′}(k) expressed by the following equation can be used in place of Rₛₛ(k)

$${R}_{ss}^{′} ( k ) = \frac{{R}_{ss} ( k )}{\sqrt{{\sum }_{n = 0}^{Lsfr1 - 1} {s}_{w}^{2} ( n - k )}} \qquad ( 6 )$$

In this case, for the purpose of reducing the computation load, it is possible that a preliminary selection is carried out by using the self-correlation Rₛₛ(k) and then a main selection from a plurality of preliminarily selected candidates is carried out by using the normalized self-correlation Rₛₛ′(k). The second ACB signal is outputted through an output terminal 76 to a second target signal calculating circuit 1310 in the FCB code generating circuit 1300, the gain code generating circuit 1400, and the second excitation signal data calculating circuit 1610. The second ACB code corresponding to the second ACB delay is outputted to the code multiplexing circuit 1020 through an output terminal 54. The filtered past excitation signal yd(n) with the delay d is outputted to the optimum ACB gain calculating circuit 2230.

Here, the second ACB delay and the second ACB code can be obtained by using the relationship of the code and the delay between the first system and the second system, instead of the above-mentioned method in which the ACB delay is selected on the basis of the least square error.

Referring to FIG. 5, a translation of codes will be explained below. FIG. 5 shows a relationship of the code and the delay between the first system and the second system. Let us consider a case, for example, where the ACB code iT1 is 56 and the corresponding ACB delay T1 is 76 in the first system. Also, let us consider a case where the ACB code iT2 is 53 and the corresponding ACB delay T2 is 76 in the second system. In this case, in order to convert the ACB code from the first system to the second system such that the ACB delay becomes consistent with each other (76, in this case), the ACB code 56 in the first system is related to the ACB code 53 in the second system. When a common ACB delay does not exist, a closest value is chosen, for example.

The optimum ACB gain calculating circuit 2230 receives the first target signal x(n) outputted from the target signal calculating circuit 2210, and receives the filtered past excitation signal Yd (n) with the delay d which is outputted from the ACB encoding circuit 2220. Here, the delay d is the second ACB delay. Next, the optimum ABC gain gₚ is calculated from the first target signal x(n) and y_{d}(n) on the basis of the following equation.

$${g}_{p} = \frac{{\sum }_{n = 0}^{Lsfr2 - 1} x ( n ) {y}_{d} ( n )}{{\sum }_{n = 0}^{Lsfr2 - 1} {y}_{d} ( n ) {y}_{d} ( n )} \qquad ( 7 )$$

The optimum ACB gain calculating circuit 2230 outputs the optimum ACB gain to a second target signal calculating circuit 1310 in the FCB code generating circuit 1300 through an output terminal 77. As for the details of the methods of calculating the second ACB signal and calculating the optimum ACB gain, the description in the section 6.1 and the section 5.6 of the conventional art document No. 3 should be referred to.

The FCB code generating circuit 1300 receives the first target signal, the second ACB signal and the optimum ACB gain outputted from the ACB code generating circuit 2200, and receives the impulse response signal outputted from the impulse response calculating circuit 1120. The FCB code generating circuit 1300 calculates the second target signal by using the first target signal, the second ACB signal, the optimum ACB gain, and the impulse response signal. Next, the FCB code generating circuit 1300 obtains an FCB signal whose deviation from the second target signal takes the minimum value, by using the second target signal, the FCB signal stored in a table built-in the FCB code generating circuit 1300, and the impulse response signal. The code, which is decodable in the second system and corresponds to the FCB signal, is outputted to the code multiplexing circuit 1020 as the second FCB code. The calculated FCB signal is outputted to the gain code generating circuit 1400 and the second excitation signal calculation 1610 as the second FCB signal.

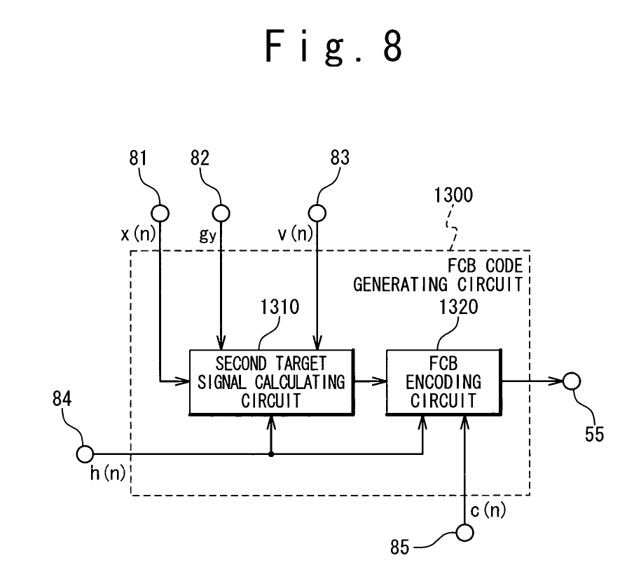

FIG. 8 is a diagram showing a configuration of the FCB code generating circuit 1300. Referring to FIG. 8, the FCB code generating circuit 1300 includes a second target signal calculating circuit 1310 and an FCB encoding circuit 1320. The second target signal calculating circuit 1310 receives through an input terminal 81 the first target signal outputted from the target signal calculating circuit 2210 in the ACB code generating circuit 2200, and receives through an input terminal 84 the impulse response signal outputted from the impulse response calculating circuit 1120. Further, the second target signal calculating circuit 1310 receives through an input terminal 83 the second ACB signal outputted from the ACB encoding circuit 2220 in the ACB code generating circuit 2200, and receives through an input terminal 82 the optimum ACB gain outputted from the optimum ACB gain calculating circuit 2230 in the ACB code generating circuit 2200. Filtered second ACB signals y(n); n=0, . . . , L_{sfr1}−1 are calculated by making the convolution between the second ACB signal and the impulse response signal. Then, the second target signal x′(n) is obtained by subtracting a signal of the product of the optimum ACB gain and Y(n) from the first target signal. Then, the second target signal is outputted to the FCB encoding circuit 1320.

The FCB encoding circuit 1320 receives the second target signal outputted from the second target signal calculating circuit 1310, and receives through an input terminal 84 the impulse response signal outputted from the impulse response calculating circuit 1120. The FCB encoding circuit 1320 includes a table in which a plurality of FCB signals are stored. The FCB encoding circuit 1320 reads the FCB signals sequentially from the table, and sequentially calculates the filtered FCB signals z(n); n=0, . . . , L_{sfr2}−1 by making the convolution between the FCB signal and the impulse response signal. Next, the FCB encoding circuit 1320 sequentially calculates normalized cross-correlations between the z(n) and the second target signal x′(n), and selects an FCB signal with which the normalized cross-correlation takes the maximum value. This corresponds to selecting an FCB signal with which the square error between x′(n) and z(n) takes the minimum value. Here, the normalized cross-correlation R_{x′z}(k) is expressed as the following equation.

$${g}_{p} = \frac{{\sum }_{n = 0}^{Lsfr2 - 1} {x}^{′} ( n ) z ( n )}{\sqrt{{\sum }_{n = 0}^{Lsfr2 - 1} z ( n ) z ( n )}} \qquad ( 8 )$$

The selected FCB signal is used as the second FCB signal c(n). The code, which is decodable in the second system and corresponds to the second FCB signal, is outputted as the second FCB code to the code multiplexing circuit 1020 through an output terminal 55. The second FCB signal is outputted through an output terminal 85 to the gain encoding circuit 1410 in the gain code generating circuit 1400 and the second excitation signal calculation 1610. With regard to the method of expressing the FCB signal, a multi-pulse signal which includes a plurality of pulses and is defined by pulse positions and pulse polarities can be used for efficiently expressing the FCB signal. In this case, the second FCB code corresponds to the pulse positions and the pulse polarities. As for the details of the encoding when the FCB signal is expressed by the multi-pulses, the description in the section 3.8 of the conventional art document No. 3 can be referred to.

Here, a similar method as in the LP coefficients code converting circuit 1100 can used instead of the above-mentioned method in which the FCB signal is selected on the basis of the least square root in the speech region. That is to say, the first FCB signal obtained in the partial speech decoding circuit 1500 is inputted, and an FCB signal whose deviation from the first FCB signal takes a minimum value is selected as the second FCB signal from the table of the FCB signal in the second system.

Moreover, when the FCB signal is expressed by the multi-pulses, the relationship of the pulse positions, the pulse polarities and the codes between the first system and the second system can be used according to a method similar to that in the ACB code generating circuit 2200. That is to say, the codes are translated by relating the values of the pulse position and the pulse polarity in the first system to those in the second system to be identical.

The gain code generating circuit 1400 receives the first target signal and the second ACB signal outputted from the ACB code generating circuit 2200, receives the second FCB signal outputted from the FCB code generating circuit 1300, and receives the impulse response signal outputted from the impulse response calculating circuit 1120. A weighed square error between the first target signal and the reconstructed speech is calculated by using the first target signal, the second ACB signal, the second FCB signal, the impulse response signal, and the ACB gain and the FCB gain stored in the table built-in the gain code generating circuit 1400. The gain code generating circuit 1400 selects an ACB gain and an FCB gain with which the weighed square error takes a minimum value. The code, which is decodable in the second system and corresponds to the selected ACB gain and the selected FCB gain, is outputted to the code multiplexing circuit 1020 as a second gain code. Moreover, the selected ACB gain and the selected FCB gain are outputted to the second excitation signal data calculating circuit 1610 as a second ACB gain and a second FCB gain, respectively.

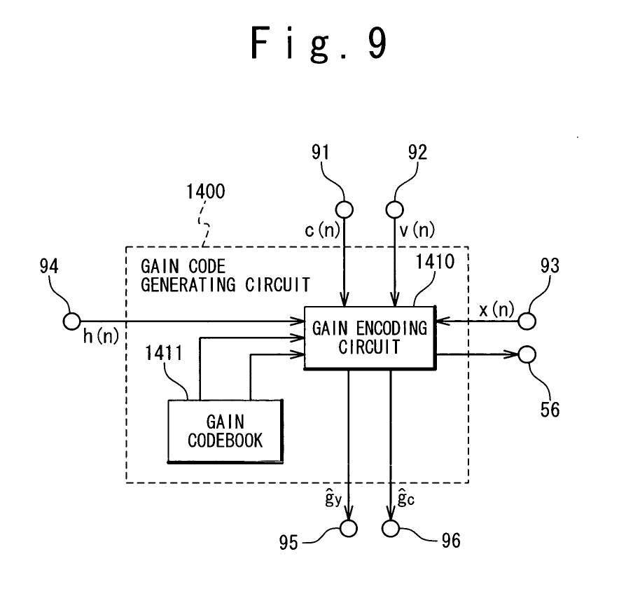

FIG. 9 is a diagram showing a configuration of the gain code generating circuit 1400. Referring to FIG. 8, the gain code generating circuit 1400 includes a gain encoding circuit 1410 and a gain codebook 1411. The gain encoding circuit 1410 receives through an input terminal 93 the first target signal outputted from the target signal calculating circuit 2210 in the ACB code generating circuit 2200, and receives through an input terminal 92 the second ACB signal outputted from the ACB encoding circuit 2220 in the ACB code generating circuit 2200. Further, the gain encoding circuit 1410 receives through an input terminal 91 the second FCB signal outputted from the FCB encoding circuit 1320 in the FCB code generating circuit 1300, and receives through an input terminal 94 the impulse response signal outputted from the impulse response calculating circuit 1120. The gain encoding circuit 1410 includes a table in which a plurality of ACB gains and a plurality of FCB gains are stored. The gain encoding circuit 1410 reads the ACB gains and the FCB gains from the table sequentially, and calculates sequentially a weighed reconstruction speech by using the second ACB signal, the second FCB signal, the impulse response signal, the ACB gain, and the FCB gain. Also, the gain encoding circuit 1410 sequentially calculates square errors between the weighed reconstruction speeches and the first target signals, and selects an ACB gain and an FCB gain with which the square error takes a minimum value. Here, the square error is expressed by the following equation.

$$E = {\sum }_{x = 0}^{Lsfr2 - 1} {( x ( n ) - ( {g}_{p}^{′} \cdot z ( n ) - {g}_{c}^{′} y ( n ) ) )}^{2} \qquad ( 9 )$$

It should be noted that g′ₚ and g′_{c} are the ACB gain and the FCB gain, respectively. Also, the y(n) is the filtered second ACB signal, which can be obtained by making the convolution between the second ACB signal and the impulse response signal. The z(n) is the filtered second FCB signal, which can be obtained by making the convolution between the second FCB signal and the impulse response signal. The weighed reconstruction speech is expressed by the following equation.
ŝ(n)=gₚ^{′}·z(n)+g_{c}^{′}·y(n) (10)

The code, which is decodable in the second system and corresponds to the selected ACB gain and the selected FCB gain, is outputted as the second gain code to the code multiplexing circuit 1020 through an output terminal 56. Further, the ACB gain and the FCB gain are outputted to the second excitation signal data calculating circuit 1610 through output terminals 95 and 96 as the second ACB gain and the second FCB gain, respectively.

Here, a method as in the LP coefficients code converting circuit 1100 can be used instead of the above-mentioned method in which the gain is selected on the basis of the least square error in the speech region. That is to say, the first gain obtained in the partial speech decoding circuit 1500 is inputted, and then a gain whose deviation from the first gain takes a minimum value is selected as the second gain from the table of the gains in the second system (the gain codebook in the second system).

The impulse response calculating circuit 1120 receives the first LP coefficients and the second LP coefficients outputted from the LSP-LPC converting circuit 1110, and makes the audibility weighing synthesis filter by using the first LP coefficients and the second LP coefficients. Further, the impulse response calculating circuit 1120 outputs the impulse response signal of the audibility weighing synthesis filter to the ACB encoding circuit 2220, the second target signal calculating circuit 1310, the FCB encoding circuit 1320, and the gain encoding circuit 1410. Here, the ACB encoding circuit 2220 is in the ACB code generating circuit 2200 of the second excitation signal data generating circuit 2600. The second target signal calculating circuit 1310 and the FCB encoding circuit 1320 are in the FCB code generating circuit 1300 of the second excitation signal data generating circuit 2600. The gain encoding circuit 1410 is in the gain code generating circuit 1400 of the second excitation signal data generating circuit 2600. As for the details of the method of calculating the impulse response signal of the audibility weighing synthesis filter, the description in the section 5.4 of the conventional art document No. 3 can be referred to.

The second excitation signal data calculating circuit 1610 receives the second ACB signal outputted from the ACB code generating circuit 2200 in the second excitation signal data generating circuit 2600, receives the second FCB signal outputted from the FCB code generating circuit 1300 in the second excitation signal data generating circuit 2600, and receives the second ACB gain and the second FCB gain outputted from the gain code generating circuit 1400 in the second excitation signal data generating circuit 2600. The second excitation signal is obtained by adding a signal of the product of the second ACB gain and the second ACB signal to a signal of the product of the second FCB gain and the second FCB signal. Then, the second excitation signal data calculating circuit 1610 outputs the second excitation signal to the second excitation signal data storage circuit 1620.

The second excitation signal data storage circuit 1620 receives and stores the second excitation signal outputted from the second excitation signal data calculating circuit 1610. Then, the second excitation signal data storage circuit 1620 outputs the second excitation signal which is inputted in the past and stored to the ACB code generating circuit 2200 in the second excitation signal data generating circuit 2600.

The above-mentioned code conversion apparatus in the first embodiment of the present invention can be realized by a control of a computer such as a digital signal processing processor and the like. As a second embodiment of the present invention, FIG. 10 schematically shows a device configuration in which the code conversion processing in the first embodiment is achieved by a computer. Referring to FIG. 10, a computer 1 includes a CPU (Central Processing Unit) 2, a memory 3, and a recording medium readout device interface 4. A recording medium readout device 5 having a recording medium 6 is provided independently of the computer 1. The recording medium 6 stores a computer program to execute the following processes:

(A) a process of obtaining data of first LP coefficients from the first codes;

(B) a process of obtaining data of first excitation signal from the first codes;

(C) a process of storing the data of first LP coefficients;

(D) a process of storing the data of first excitation signal;

(E) a process of calculating data of first LP coefficients from the past data of first LP coefficients which are stored;

(F) a process of calculating data of first excitation signal from the past data of first excitation signal which are stored;

(G) a process of obtaining data of second LP coefficients from the data of first LP coefficients; and

(H) a process of obtaining data of second excitation signal from the data of first excitation signal.

More specifically, in the computer 1 executing the program read out from the recording medium 6, the code conversion processing is carried out in which the first codes obtained by encoding a speech in a first encoding-decoding apparatus are converted into the second codes which are decodable in a second encoding-decoding apparatus. As shown in FIG. 12, the recording medium 6 stores a computer program to execute the following processes:

(a) a process of obtaining data of first LP coefficients from the first codes;

(b) a process of obtaining first LP coefficients from the data of first LP coefficients;

(c) a process of storing the data of first LP coefficients;

(d) a process of calculating data of first LP coefficients from the past data of first LP coefficients which are stored;

(e) a process of obtaining data of second LP coefficients from the data of first LP coefficients;

(f) a process of obtaining second LP coefficients from the data of second LP coefficients;

(g) a process of obtaining data of a first excitation signal from the first codes;

(h) a process of storing the data of first excitation signal;

(i) a process of calculating data of first excitation signal from the past data of first excitation signal which are stored;

(j) a process of obtaining a first excitation signal from the data of first excitation signal;

(k) a process of producing a first speech signal by driving a filter having the first LP coefficients or the second LP coefficients by using the excitation signal; and

(l) a process of obtaining data of a second excitation signal from the first LP coefficients, the second LP coefficients and the first speech signal.

The program stored in the recording medium 6 is read out to the memory 3 through the recording medium readout device 5 and the recording medium readout device interface 4, and then is executed. The above-mentioned program may be stored in a nonvolatile memory such as a flash memory, a mask ROM and the like. The recording medium includes a nonvolatile memory, a CD-ROM, an FD, a digital versatile disk (DVD), a magnetic tape (MT), a portable HDD and so on. Moreover, the recording medium may include a communication medium of wired or wireless communication to transmit the program, for example, when the program is transmitted from a server to a computer.

According to the present invention, as described above, it is possible to reduce the deterioration in quality of the speech signal decoded from the second codes, the deterioration being caused by a process in which a speech signal with deterioration generated from the past speech parameters in the first system is re-analyzed and decoded in the second system, when the first codes is unavailable. The reason is comes from a fact that the present invention is designed such that the second codes are obtained by using directly the speech parameters which are obtained in the past according to the first system and stored.

1. (canceled)

2. A method of converting code which converts first codes based on a first system to second codes based on a second system, comprising:
obtaining data of first linear prediction coefficients from said first codes;
obtaining data of first excitation signal from said first codes;
storing said data of first linear prediction coefficients;
storing said data of first excitation signal;
calculating current data of first linear prediction coefficients from past data of first linear prediction coefficients which are stored;
calculating current data of first excitation signal from past data of first excitation signal which are stored;
obtaining data of second linear prediction coefficients from said current data of first linear prediction coefficients; and
obtaining data of second excitation signal from said current data of first excitation signal,
wherein when said first codes are unavailable, said second codes are obtained by directly using speech parameters which are ever decoded in accordance with said first system and are stored.

3. The method of converting code according to claim 2, further comprising:
generating a first speech signal by driving a filter having any of first linear prediction coefficients derived from said current data of first linear prediction coefficients and second linear prediction coefficients derived from said data of second linear prediction coefficients by using a first excitation signal derived from said current data of first excitation signal; and
obtaining data of second excitation signal from said first speech signal and any of said first linear prediction coefficients and said second linear prediction coefficients.

4. The method of converting code according to claim 2,
wherein said data of excitation signal includes any of an adaptive codebook data, a fixed codebook data and a gain data.

5. (canceled)

6. A code conversion apparatus, which converts first codes based on a first system to second codes based on a second system, comprising:
a linear prediction coefficients data decoding circuit configured to obtain data of first linear prediction coefficients from said first codes;
an excitation signal data decoding circuit configured to obtain data of first excitation signal from said first codes;
a linear prediction coefficients data storage circuit configured to store said data of first linear prediction coefficients;
an excitation signal data storage circuit configured to store said data of first excitation signal;
a linear prediction coefficients data calculating circuit configured to calculate current data of first linear prediction coefficients from past data of first linear prediction coefficients which are stored;
an excitation signal data calculating circuit configured to calculate current data of first excitation signal from past data of first excitation signal which are stored;
a linear prediction coefficients data encoding circuit configured to obtain data of second linear prediction coefficients from said current data of first linear prediction coefficients; and
an excitation signal data generating circuit configured to obtain data of second excitation signal from said current data of first excitation signal,
wherein when said first codes are unavailable, said second codes are obtained by directly using speech parameters which are ever decoded in accordance with said first system and are stored.

7. The code conversion apparatus according to claim 6, further comprising:
a partial decoding circuit configured to generate a first speech signal by driving a filter having any of first linear prediction coefficients derived from said current data of first linear prediction coefficients and second linear prediction coefficients derived from said data of second linear prediction coefficients by using a first excitation signal derived from said current data of first excitation signal; and
an excitation signal data generating circuit configured to obtain data of second excitation signal from said first speech signal and any of said first linear prediction coefficients and said second linear prediction coefficients.

8. The code conversion apparatus according to claim 6,
wherein said data of excitation signal includes any of an adaptive codebook data, a fixed codebook data and a gain data.

9. (canceled)

10. A computer program product embodied on a computer-readable medium and comprising code that when executed, causes a computer to perform processes, said computer serving as a code conversion apparatus which converts first codes based on a first system to second codes based on a second system,
said processes comprising:
a process of obtaining data of first linear prediction coefficients from said first codes;
a process of obtaining data of first excitation signal from said first codes;
a process of storing said data of first linear prediction coefficients;
a process of storing said data of first excitation signal;
a process of calculating current data of first linear prediction coefficients from past data of first linear prediction coefficients which are stored;
a process of calculating current data of first excitation signal from past data of first excitation signal which are stored;
a process of obtaining data of second linear prediction coefficients from said current data of first linear prediction coefficients; and
a process of obtaining data of second excitation signal from said current data of first excitation signal,
wherein when said first codes are unavailable, said second codes are obtained by directly using speech parameters which are ever decoded in accordance with said first system and are stored.

11. The computer program product according to claim 10,
wherein said processes further comprising:
a process of generating a first speech signal by driving a filter having any of first linear prediction coefficients derived from said current data of first linear prediction coefficients and second linear prediction coefficients derived from said data of second linear prediction coefficients by using a first excitation signal derived from said current data of first excitation signal; and
a process of obtaining data of second excitation signal from said first speech signal and any of said first linear prediction coefficients and said second linear prediction coefficients.

12. The computer program product according to claim 10,
wherein said data of excitation signal includes any of an adaptive codebook data, a fixed codebook data and a gain data.

13. (canceled)

14. The method of converting code according to claim 3,
wherein said data of excitation signal includes any of an adaptive codebook data, a fixed codebook data and a gain data.

15. The code conversion apparatus according to claim 7,
wherein said data of excitation signal includes any of an adaptive codebook data, a fixed codebook data and a gain data.

16. The computer program product according to claim 11,
wherein said data of excitation signal includes any of an adaptive codebook data, a fixed codebook data and a gain data.
